(19) United States
(12) Patent Application Publication
(10) Pub. No.: US 2010/0095544 A1
(43) Pub. Date: Apr. 22, 2010

(54) FLANGE ALIGNMENT PIN

(75) Inventor: Peter HASELOH, Kindersley (CA)

Correspondence Address: DAVIS & BUJOLD, P.L.L.C., 112 PLEASANT STREET, CONCORD, NH, 03301, US

(73) Assignee: INNOVATIVE MICROELECTRONICS INC., Kindersley (CA)

(21) Appl. No.: 12/580,442

(22) Filed: Oct. 16, 2009

(30) Foreign Application Priority Data
Oct. 20, 2008 (CA) 2642141

(51) Int. Cl. G01D 21/00

(52) U.S. Cl. 33/645

(57) ABSTRACT

A flange alignment pin which includes a non-ferrous pin with a magnetic positioner secured to and extending radially from the pin. The magnetic is positioned to serve as means by which the pin is maintained in position by magnetic attraction against a flange made of ferrous material

### FIELD

This patent relates to an alignment pin that is used to align bolt hole openings in flanges, in order to insert bolts through the openings to secure the flanges together.

### BACKGROUND

Flange alignment pins are commonly inserted into one or more aligned openings in flanges, in order to align the remaining openings so that bolts may be inserted into the openings to secure the flanges together. A flange alignment pin in common usage consists of a two-piece unit, a male piece with an external thread and a female piece with an internal thread. When using this alignment pin, a pipefitter inserts the male piece through the aligned openings in the flanges and then screws the female piece onto the male piece.

### SUMMARY

There is provided a flange alignment pin which includes a non-ferrous pin with a magnetic positioner secured to and extending radially from the pin. The magnetic is positioned to serve as means by which the pin is maintained in position by magnetic attraction against a flange made of ferrous material

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a flange alignment pin.

FIG. 2 is a end elevation view of the flange alignment pin.

FIG. 3 is an exploded top plan view of the flange alignment pins being used to align a flange.

FIG. 4 is a side elevation view of a second embodiment of the flange alignment pin.

### DETAILED DESCRIPTION

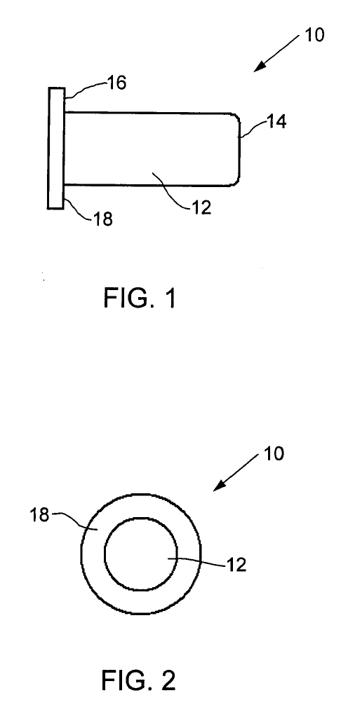

A first embodiment of flange alignment pin generally identified by reference numeral 10, will now be described with reference to FIG. 1 through 3. A second embodiment of flange alignment pin generally identified by reference numeral 100, will then be described with reference to FIG. 4.

Structure and Relationship of Parts of First Embodiment:

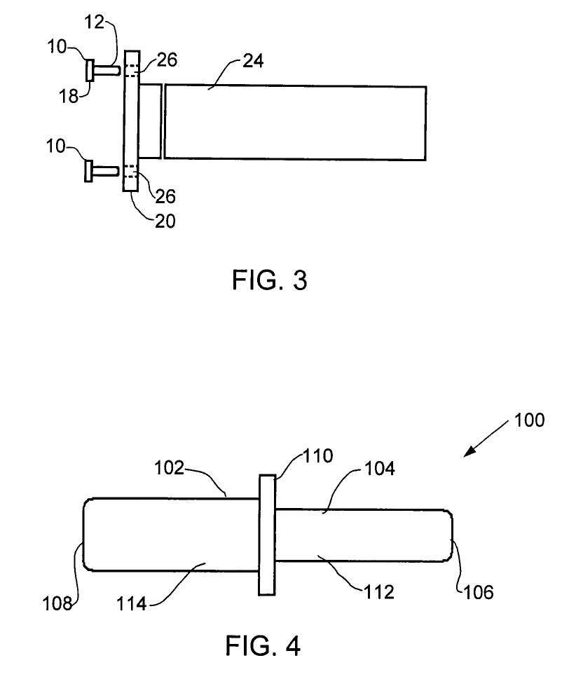

Referring to FIG. 1, flange alignment pin 10 includes a non-ferrous pin 12 having a first end 14 and a second end 16. A magnetic positioner 18 is positioned at first end 14 and extends radially from pin 12. Referring to FIG. 2, in the illustrated embodiment, magnetic positioner 18 is in the form of an annular ring. It will be apparent that, in this embodiment, it could also take the form of an end cap. Although a circular magnetic positioner is more convenient, there is no reason why magnetic positioner 18 could not be square or some other form of polygon. As is illustrated in FIG. 3, and will hereinafter be further described in relation to operation, magnetic positioner 18 serves as means by which pin 12 is maintained in position by magnetic attraction against a flange 20 made of ferrous material.

Operation of First Embodiment:

Referring to FIG. 3, flange alignment pin 10 is used to help align flange 20 on for example, a pipe 24, or other body that flange 20 may be attached to. Flange 20 and pipe 24 are first aligned using known techniques, such as by clamping flange 20, and positioning pipe 24 adjacent to flange 20 on a support (not shown). Non-ferrous pin 12 is then inserted through flange holes 26 until magnetic positioner magnetically attaches to flange 20. It will be apparent that, as flange alignment pin 10 relies on magnetism, it is primarily suitable for flanges that are magnetic. Other flange alignment pins 10 are inserted into other holes 26, until a sufficient number are included to properly align flange 20 and pipe 24. For example, as shown in the top view in FIG. 3, flange alignment pins 10 are inserted into the two uppermost holes 26 to allow a spirit level to be placed across them to properly align flange 20. As pins 12 approach flange 20, magnetic positioner 18 pulls it into place. This allows a user to install flange alignment pins 10 quickly, with one hand if necessary, leaving the other free to support flange 20 or some other equipment. Once aligned, and the position of flange 20 has been secured by welding or otherwise, flange alignment pins 10 may then be removed.

Structure and Relationship of Parts of Second Embodiment:

Referring to FIG. 4, flange alignment pin 100 includes a non-ferrous pin 102 having an exterior surface 104, a first end 106 and a second end 108. A magnetic positioner 110 in the form of an annular ring is secured to exterior surface 104 of the pin in an intermediate position between first end 106 and second end 108. Magnetic positioner 110 extends radially from pin 102. A first portion 112 of pin 102 that extends from magnetic positioner 110 to first end 106 has a first diameter, and a second portion 114 of pin 102 extends from magnetic positioner 110 to second end 108 has a second diameter.

Operation of Second Embodiment:

The second embodiment is used in a similar manner to flange alignment pin 10 as shown in FIG. 3, as magnetic positioner 110 serves as means by which pin 102 is maintained in position by magnetic attraction against a flange 20 made of ferrous material. However, flange alignment pin 100 shown in FIG. 4 has the advantage of being reversible, such that a single alignment pin 100 is suitable for use with two different sizes of flange holes. In addition to being reversible, a spirit level may be supported on the side of pin 100 that is not inserted into the flange hole.

In a preferred use, a set of flange alignment pins 10 would be provided to cover various flange hole sizes. For example, a set of three flange alignment pins 100 with two diameters each could cover range of flange hole sizes such as: ⅝″, ¾″, ⅞″, 1″, 1⅛″, and 1¼″.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A flange alignment pin, comprising:
a non-ferrous pin;
a magnetic positioner secured to and extending radially from the pin, the magnetic positioner serving as means by which the pin is maintained in position by magnetic attraction against a flange made of ferrous material.

2. The flange alignment pin of claim 1, wherein the magnetic positioner is positioned at one end of the pin.

3. The flange alignment pin of claim 1, wherein the pin has a first end and a second end and the magnetic positioner is positioned in an intermediate position between the first end and the second end.

4. The flange alignment pin of claim 3, wherein a first portion of the pin extending from the magnetic positioner to the first end has a first diameter and a second portion of the pin extending from the magnetic positioner to the second end has a second diameter.

5. The flange alignment pin of claim 1, wherein the magnetic positioner is an annular ring secured to an exterior surface of the pin.

6. A flange alignment pin, comprising:
a non-ferrous pin having a first end and a second end;
a magnetic positioner positioned at the first end and extending radially from the pin, the magnetic positioner serving as means by which the pin is maintained in position by magnetic attraction against a flange made of ferrous material.

7. A flange alignment pin, comprising:
a non-ferrous pin having a first end and a second end;
a magnetic positioner positioned in an intermediate position between the first end and the second end and extending radially from the pin, with a first portion of the pin extending from the magnetic positioner to the first end has a first diameter and a second portion of the pin extending from the magnetic positioner to the second end has a second diameter, the magnetic positioner serving as means by which the pin is maintained in position by magnetic attraction against a flange made of ferrous material.

8. The flange alignment pin of claim 7, wherein the magnetic positioner is an annular ring secured to an exterior surface of the pin.

9. A flange alignment pin, comprising:
a non-ferrous pin having an exterior surface, a first end and a second end;
a magnetic positioner in the form of an annular ring secured to the exterior surface of the pin in an intermediate position between the first end and the second end and extending radially from the pin, with a first portion of the pin extending from the magnetic positioner to the first end has a first diameter and a second portion of the pin extending from the magnetic positioner to the second end has a second diameter, the magnetic positioner serving as means by which the pin is maintained in position by magnetic attraction against a flange made of ferrous material.
